(19) United States
(12) Patent Application Publication
(10) Pub. No.: US 2021/0165437 A1
(43) Pub. Date: Jun. 3, 2021

(54) Asynchronous Non-Linear Control of Digital Linear Voltage Regulator

(71) Applicant: Georgia Tech Research Corporation, Atlanta, GA (US)

(72) Inventors: Saad Bin Nasir, Atlanta, GA (US); Arijit Raychowdhury, Atlanta, GA (US); Madhavan Swaminathan, Atlanta, GA (US)

(21) Appl. No.: 16/772,945

(22) PCT Filed: Dec. 13, 2018
(86) PCT No.: PCT/US2018/065493

§ 371 Date: Jun. 15, 2020

Related U.S. Application Data
(60) Provisional application No. 62/597,981, filed on Dec. 13, 2017.

(51) Int. Cl. G05F 1/59; H02M 3/158; H02M 3/157

(52) U.S. Cl. CPC G05F 1/59; H02M 2001/0012; H02M 3/157; H02M 3/1584

(57) ABSTRACT

A digital low dropout (LDO) voltage regulator enabling on-chip fine-grain power management in multi-core micro-processor and system-on-a-chip platforms to increase system level energy efficiency. Its design synthesizability with automatic placement and routing enables per-core dynamic voltage and frequency scaling with quick design turnaround. To enable per-core voltage regulation, the digital LDO is designed in a 65 nm complementary metal-oxide-semiconductor process. It exhibits core-level high load current driving capability of up to 125 mA and a large voltage regulation range of 0.15 V to 1.15 V.

### BACKGROUND OF THE INVENTION

### 1. Field of the Invention

The present invention relates generally to voltage regulators, and more specifically to low dropout regulators.

### 2. Description of Related Art

There is an increasing demand for electronic devices to be smaller, faster, and more efficient. The low dropout (LDO) voltage regulator has emerged as a suitable candidate in these higher performing power supply circuits for on-chip voltage conversion and regulation of digital load circuits.

Due to spacing constraints of portable devices, circuits for multiple functions may require multiple voltage levels on the same chip. Therefore, voltage regulators are utilized to protect circuits from fluctuations in the power supply that may occur from crosstalk or digital switching. High fluctuations in the power supply are not desirable because they may damage sensitive circuit components, disrupt biasing or prevent circuits from working.

To regulate an output voltage from a higher input voltage, a voltage regulator may compare its output voltage with a fixed reference voltage, amplify the difference, and use feedback to match the output voltage to the reference voltage. There are several types of voltage regulators, namely switching regulators, linear regulators, and cascaded regulators that comprise both switching and linear regulators in cascaded architecture.

A special type of linear regulators is the LDO regulator, which has a characteristically low dropout voltage, the minimum voltage required across the regulator to maintain regulation. Dropout voltage is the input-to-output differential voltage at which the circuit ceases to regulate against further reductions in input voltage; this point occurs when the input voltage approaches the output voltage. In a typical LDO regulator circuit, in the dropout region, the PMOS pass element is simply a resistor, and dropout is expressed in terms of its on-resistance.

The LDO is named for the small difference between its required supply voltage and the desired output voltage. A regulator that has a dropout voltage of one volt (V) or less may be considered a low dropout regulator. For example, an LDO may be used in an application that requires a 3.3 V output from a 3.6 V battery. In this example, the LDO must have a dropout voltage of 300 mV or less because the input voltage minus the voltage drop across the LDO equals the output voltage.

Additionally, an LDO may be characterized as high power or low power. High power LDOs can yield currents that are equal to or greater than 1 ampere (A) to the output, thus these LDOs are also referred to as LDOs with a high current rating. In contrast, low power LDOs typically have a maximum output current of less than 1 A.

There are both analog and digital LDOs. The trade-offs on voltage regulation metrics offered by an analog LDO are different from that of a digital LDO. These metrics are tailored for powering digital circuits that have large operational ranges (voltage and current) and undergo sudden transitions. A digital LDO allows very low supply voltage operation and high current density. Low supply voltage operation is achieved through digital logic and absence of any biasing requirements. A higher current density is achieved as the power transistors in digital LDO are completely turned on or off in contrast to an analog LDO, where the power transistor is maintained in weak inversion or saturation.

Complete on/off switching of power transistors further results in higher voltage droop reduction and faster recovery due to sudden load current transients. On the downside, a digital LDO has low small-signal gain under limited power budget for operational clock generation and distribution. As a result, metrics relevant to noise-sensitive analog load circuits like voltage ripple and power supply noise rejection are inherently low.

The prime motivation for employing digital LDOs stem from the fact that they can enable on-chip fine-grain power management. Thanks to their digital logic synthesizability and automated placement and routing, they can enable per-core dynamic voltage and frequency scaling (DVFS) in large microprocessors and systems-on-chip (SoC) at a low design complexity and integration time.

In its basic form, a digital LDO discretizes both control and power stage by using a clock for synchronous sensing and on/off switching of small power transistors instead of a single large power transistor. This quantized nature results in an inherent trade-off between the transient and steady-state performance of a digital LDO. A faster sampling clock can improve transient performance against sudden load changes, but during steady-state it results in an increased voltage ripple due to limit cycle oscillations.

Thus, it would be beneficial to develop a digital LDO that decoupled steady-state response from transient performance. It would be further beneficial to provide a digital LDO that was suitable for load circuits that can remain operational when regulated voltage is above or equal to the reference voltage—as opposed to just being equal to it. It is to such a voltage regulator that the present invention is directed.

### SUMMARY OF THE INVENTION

The present invention provides per-core voltage regulation, employing asynchronous, non-linear control. An exemplary design allows maximum digital process flow synthesizability, fast asynchronous sensing for transient events and uses nonlinear control to achieve fast voltage droop mitigation.

The present digital LDO enables on-chip fine-grain power management in multi-core microprocessor and system-on-a-chip platforms to increase system level energy efficiency. Its design synthesizability with automatic placement and routing can enable per-core DVFS with quick design turnaround. To enable per-core voltage regulation, in an exemplary embodiment, the present digital LDO is designed in a 65 nm complementary metal-oxide-semiconductor (CMOS) process. An exemplary LDO exhibits core-level high load current driving capability of up to 125 mA and a large voltage regulation range of 0.15 V to 1.15 V.

An exemplary design employs asynchronous nonlinear control to achieve fast voltage droop mitigation under large load transient events. Measurements show a peak current efficiency of 99.9% and greater than 99.5% at a light load of only 4 mA and 1 nF load decoupling capacitance.

The efficiency of LDO regulators is limited by the quiescent current and input/output voltages. To have a high efficiency, drop out voltage and quiescent current must be minimized. In addition, the voltage difference between input and output must be minimized since the power dissipation of LDO regulators accounts for the efficiency. The input/output voltage difference is an intrinsic factor in determining the efficiency, regardless of the load conditions.

To decouple steady-state response from transient performance, an exemplary digital LDO asynchronously senses load transients to differentiate it from steady-state operation. This obviates the need for employing a fast clock to meet a transient specification significantly saving power otherwise, expanded in fast clock generation and distribution.

In conventional LDOs, the transient response is the maximum allowable output voltage variation for a load current step change. The transient response is a function of the output capacitor value, the equivalent series resistance of the output capacitor, the bypass capacitor that is usually added to the output capacitor to improve the load transient response, and the maximum load-current.

Secondly, to enable ultra-fast voltage droop recovery, non-linear control is employed that results in maximum droop mitigation against large load transients under limited decoupling capacitance budget.

This topology is especially suitable for load circuits that can remain operational when regulated voltage is above or equal to the reference voltage as opposed to just being equal to it. Both asynchronous sensing and nonlinear control are integrated in a basic digital LDO topology to retain a wide operational current and voltage range.

The present wide dynamic range digital low dropout voltage regulator is capable of enabling per-core DVFS. The design uses asynchronous nonlinear control to achieve fast voltage droop mitigation under large load current steps. Measurements on a test-chip built in 65 nm CMOS show a load current range of up to 125 mA and regulated voltage range of 0.15 V to 1.15 V from a supply voltage of 1.2 V. The design shows greater than 99.5% current efficiency at a light load of only 4 mA with 1 nF decoupling capacitance.

In one exemplary embodiment, the present invention is a voltage regulator comprising an output configured to provide an output voltage, power transistors configured to switch between an on state and an off state, power regulation circuitry configured switch, synchronously with the clock, the power transistors, load sensing circuitry configured to sense, asynchronously with the clock, a decrease in the output voltage, and control circuitry configured to transition, asynchronously with the clock, power transistors in the off state to the on state.

The control circuitry can be configured to transition, asynchronously with the clock, every power transistor in the voltage regulator in the off state to the on state.

The load sensing circuitry can comprise a clockless comparator.

The load sensing circuitry can comprise an active load differential amplifier, a common source amplifier, and fast slew rate registers.

The control circuitry can comprise shift registers, wherein an output of the shift registers is in communication with the power transistors, and wherein the shift registers each comprise a reset input.

The voltage regulator can be configured to exhibit core-level load current driving capability of up to approximately 125 mA, and a voltage regulation range of approximately 0.15 V to approximately 1.15 V.

The voltage regulator can be configured to have a peak current efficiency of greater than approximately 99.5% at a load of approximately 4 mA and approximately 1 nF load decoupling capacitance.

The voltage regulator can have a nominal supply voltage of approximately 1.2 V.

The voltage regulator can be configured to deliver a maximum load current of approximately 125 mA at a dropout voltage of approximately 600 mV occupying a total area of approximately 0.061 mm² excluding decoupling capacitor area.

The voltage regulator can be configured to provide a regulated output voltage from approximately 0.15 V to approximately 1.15 V with a minimum operational dropout voltage of approximately 50 mV.

In another exemplary embodiment, the present invention is a voltage regulator comprising an output configured to provide an output voltage, power transistors configured to switch between an on state and an off state, shift registers configured to control the switching of the power transistors, wherein at least a portion of the shift registers each comprise a reset input, a clockless comparator configured to compare the output voltage to a reference voltage, wherein the clockless comparator is in communication with at least a portion of the reset inputs.

The voltage regulator can be configured to exhibit core-level load current driving capability of up to approximately 125 mA, and a voltage regulation range of approximately 0.15 V to approximately 1.15 V.

The voltage regulator can be configured to have a peak current efficiency of greater than approximately 99.5% at a load of approximately 4 mA and approximately 1 nF load decoupling capacitance.

The voltage regulator can have a nominal supply voltage of approximately 1.2 V.

The voltage regulator can be configured to deliver a maximum load current of approximately 125 mA at a dropout voltage of approximately 600 mV occupying a total area of approximately 0.061 mm² excluding decoupling capacitor area.

The voltage regulator can be configured to provide a regulated output voltage from approximately 0.15 V to approximately 1.15 V with a minimum operational dropout voltage of approximately 50 mV.

In another exemplary embodiment, the present invention is a method for asynchronous voltage recovery comprising providing a voltage regulator comprising digital power transistors, resettable registers, and a voltage comparator, comparing, with the voltage comparator, an output voltage of the voltage regulator to a reference voltage, providing, by the comparator, a reset signal to the resettable registers, providing, by the resettable registers, an asynchronous control signal, and activating, in response to the asynchronous control signal, each of the digital power transistors to an on state.

The method can further comprise exhibiting core-level load current driving capability of up to approximately 125 mA, and a voltage regulation range of approximately 0.15 V to approximately 1.15 V.

The voltage regulator can be configured to have a peak current efficiency of greater than approximately 99.5% at a load of approximately 4 mA and approximately 1 nF load decoupling capacitance.

The voltage regulator can have a nominal supply voltage of approximately 1.2 V.

The voltage regulator can be configured to deliver a maximum load current of approximately 125 mA at a dropout voltage of approximately 600 mV occupying a total area of approximately 0.061 mm² excluding decoupling capacitor area.

The voltage regulator can be configured to provide a regulated output voltage from approximately 0.15 V to approximately 1.15 V with a minimum operational dropout voltage of approximately 50 mV.

These and other objects, features and advantages of the present invention will become more apparent upon reading the following specification in conjunction with the accompanying drawing figures.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention;

FIG. 1 is the architecture of the present invention according to an exemplary embodiment.

FIG. 2 is a design of an asynchronous continuous-time comparator of the present invention according to an exemplary embodiment.

FIG. 3 is a chip micrograph with circuit placement details of the present invention according to an exemplary embodiment. The testing is performed on a QFN packaged die.

FIG. 4 is a Shmoo plot showing the wide operational range of the present digital LDO according to an exemplary embodiment. Load current is not constant at different VN and VOUT.

FIG. 5 is a graph of measured load regulation, a measure of the circuit's ability to maintain the specified output voltage under varying load conditions.

FIG. 6 is a graph of measured load regulation with V_{REF}=670 mV.

FIGS. 7(a) and (b) are transient plots showing load step and release for (a) a baseline digital LDO, and (b) an exemplary digital LDO. V_{REF}=87 5 mV, V_{REF}−Δ=750 mV.

FIG. 8 illustrates transient performance against large load current step and release with asynchronous non-linear control. V_{REF}=87 5 mV, V_{REF}−Δ=750 mV.

FIG. 9 illustrates transient performance of a baseline digital LDO at V_{REF}=150 mV and V_{IN}=1.2 V.

FIG. 10 is a graph of measured static current efficiency of the present invention according to an exemplary embodiment.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways.

As used in the specification and the appended Claims, the singular forms “a,” “an” and “the” include plural references unless the context clearly dictates otherwise. For example, reference to a component is intended also to include a composition of a plurality of components. References to a composition containing “a” constituent is intended to include other constituents in addition to the one named.

In describing exemplary embodiments, terminology will be resorted to for the sake of clarity. It is intended that each term contemplates its broadest meaning as understood by those skilled in the art and includes all technical equivalents that operate in a similar manner to accomplish a similar purpose.

Ranges may be expressed as from “about” or “approximately” or “substantially” one value and/or to “about” or “approximately” or “substantially” another value. When such a range is expressed, other exemplary embodiments include from the one value and/or to the other value.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Similarly, as used herein, “substantially free” of something, or “substantially pure”, and like characterizations, can include both being “at least substantially free” of something, or “at least substantially pure”, and being “completely free” of something, or “completely pure”.

As used herein, the term “identical” refers to values that are close to each other within the range of manufacturing tolerances.

“Comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

The characteristics described as defining the various elements of the invention are intended to be illustrative and not restrictive. For example, if the characteristic is a material, the material includes many suitable materials that would perform the same or a similar function as the material(s) described herein are intended to be embraced within the scope of the invention. Such other materials not described herein can include, but are not limited to, for example, materials that are developed after the time of the development of the invention.

Embodiments of systems, devices and methods may be implemented in various architectures, each with various configurations. Several detailed features and embodiments are discussed herein. Functionality may be referenced as logic, components, modules, circuits and the like. Functionality may be implemented in digital, analog or combined components. Functionality may be implemented in hardware, software or a combination thereof.

As discussed, LDO regulators are favored in portable applications, particularly mobile products that are battery powered, such as cellular phones, camera recorders and laptops. To increase battery life and efficiency, these portable electronic devices require low voltage and low quiescent current flow, which is the current required to power the internal circuitry of the LDO when the external load current is zero. Quiescent, or ground current, is the difference between input and output currents. Low quiescent current is necessary to maximize the current efficiency.

Quiescent current consists of bias current (such as band-gap reference, sampling resistor, and error amplifier currents) and the gate drive current of the series pass element, which do not contribute to output power. The value of quiescent current is mostly determined by the series pass element, topologies, ambient temperature, etc.

For bipolar transistors, the quiescent current increases proportionally with the output current because the series pass element is a current-driven device. In addition, in the dropout region the quiescent current can increase due to the additional parasitic current path between the emitter and the base of the bipolar transistor, which is caused by a lower base voltage than that of the output voltage. For MOS transistors, the quiescent current has a near constant value with respect to the load current since the device is a voltage-driven device. The only things that contribute to the quiescent current for MOS transistors are the biasing currents of band-gap, sampling resistor, and error amplifier. In applications where power consumption is critical, or where small bias current is needed in comparison with the output current, an LDO voltage regulator using MOS transistors is essential.

Low voltage is a natural consequence of improving chip process technology that leads to higher packing densities. Thus, voltage regulators that operate at low voltages and low quiescent currents while producing precise output voltages are desirable.

Motivation And Operation Of Asynchronous Non-Linear Control

Asynchronous Voltage Droop Detection

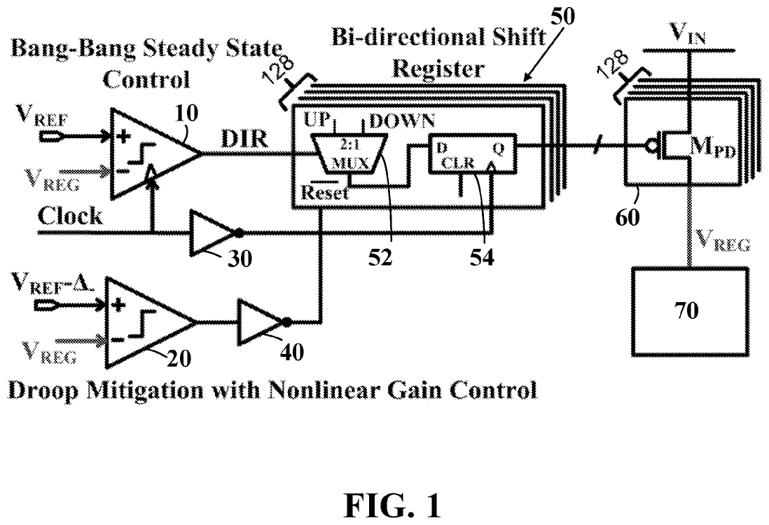

The operation of a basic digital LDO utilizes a master clock to sense and actuate power transistors as shown in FIG. 1. It has been well established that increasing clock frequency at iso-load condition makes the LDO loop underdamped. It results in long settling time after a load transient due to decreased phase margin and a large voltage ripple in steady-state. Ultimately unstable behavior or loss of regulation can occur if the clock frequency is increased to a very high value. Therefore, an upper limit on the operational clock frequency limits the maximum achievable transient performance which is of tantamount importance in digital circuits with small decoupling capacitor budget.

As a solution, voltage droop detection using a clock-less comparator in high performance modes decouples the transient performance of the LDO from the master clock frequency. Biased clock-less comparators can outperform sense amplifier-based comparators at high voltages where load transients also exhibit large changes. As the supply voltage goes down, the magnitude of load current steps also decreases and regular droop detection techniques can be employed.

Non-Linear Control

In the inventive non-linear control, all the power transistors of the digital LDO are asynchronously turned on when a voltage droop is detected. This results in maximum voltage droop mitigation as compared to any other control action which turns on a lesser number of power transistors. Due to this non-linear droop mitigation, a large mismatch between load and supply current can induce an unfavorable large overshoot. The clamping effect of the power transistors and enough decoupling capacitor on the supply node will keep the overshoot equal or below the supply voltage.

Nevertheless, this nonlinear action results in extra power losses approximated as:

$${P}_{LOSS} = \frac{{C}_{{g}^{′}} {V}_{DD}^{2}}{{T}_{s}} + \frac{{{C}_{LOAD} ( {V}_{DD} - {V}_{REF} )}^{2}}{{T}_{1}} \qquad ( 1 )$$

Wherein C_{g′} is the gate capacitance of surplus power transistors than required by the load and Trefers to the gate driver rise-time. C_{LOAD} is the load capacitance on the regulated voltage. T₁ is the time difference when regulated voltage reaches its peak value and when it is equal to the reference voltage. Assuming a capacitive load, T₁ is inversely proportional to the load current. Similarly, effective C_{g′} increases as load current decreases. Therefore, the power overhead incurred in the digital LDO operation increases if a small load step triggers the non-linear control action.

To prevent unnecessary dynamic power loss, the voltage droop detection threshold must be placed to account for only large load current transients. To guarantee a stable voltage settling after a non-linear control action and the subsequent voltage overshoot, a low frequency master clock must be employed to allow the regulated voltage to return smoothly to reference voltage without any oscillations.

Architecture and Design

The basic digital LDO structure is based on the design shown in FIG. 1. The present invention comprises an analog/continuous time comparator 10 to compare V_{IN} against V_{REF}. Analog/continuous time comparator 20 (or droop detector 20) is used to compare V_{IN} against V_{REF}−Δ. The architecture further comprises inverters 30, 40 a bi-directional shift register 50, 2:1 multiplexer 52, flip-flops 54, power FETs or power PFETs 60, and load 70 (or load circuit 70 or load current 70).

This design offers a simple shift register based control logic that is readily synthesizable as a digital circuit. A sense amplifier-based comparator detects the difference between V_{REG} and V_{REF}. If V_{REG}>V_{REF}, a single power transistor is turned off by using right shift of all the values in the shift register and if V_{REG}<V_{REF} left shift of all the values is performed. In a current implementation, the power stage comprises of 128 equally-sized power metal-oxide-semiconductor field-effect transistors (MOSFETs) controlled through 128-bit shift register. The sense amplifier operates on the positive clock edge followed by shift register action on the following clock edge. This dual edge logic reduces the latency between sampling and actuation of the power stage.

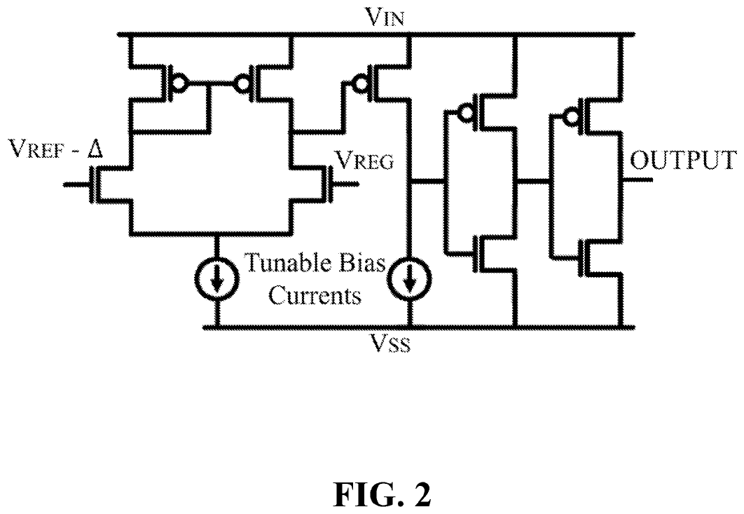

Voltage droop detection is performed using the continuous-time comparator 20 comprising a two-stage amplifier followed by fast slew rate inverters as shown in FIG. 2. As shown, the droop detector 20 comprises a left differential input, a right differential input, current-mirror diode-connected P-type metal-oxide-semiconductor (PMOS), current-mirror PMOS, a first stage PMOS, a buffer PMOS, an output PMOS, a first and second biasing current source, buffer N-type metal-oxide-semiconductor (NMOS), and NMOS.

The first stage of the amplifier is an active-loaded differential amplifier. Common-source amplifier based second stage is used to enhance the gain of the comparator. The two-stage amplifier is followed by fast slew rate inverters to increase the driving capability and decrease the latency of the comparator action. Tail current of both the stages of the two-stage amplifier is externally tunable to allow offset and mismatch compensation. The comparator compares V_{REF}−Δ with V_{REG} to determine the voltage droop. In case of a voltage droop, the output of the comparator is propagated as a reset signal to all of the 128 bits of the shift register flip-flops. This action enables all the power transistors resulting in maximum possible voltage droop mitigation. The comparator topology is kept simple to allow fast decision at minimum possible quiescent current and design overhead.

Measurement Results

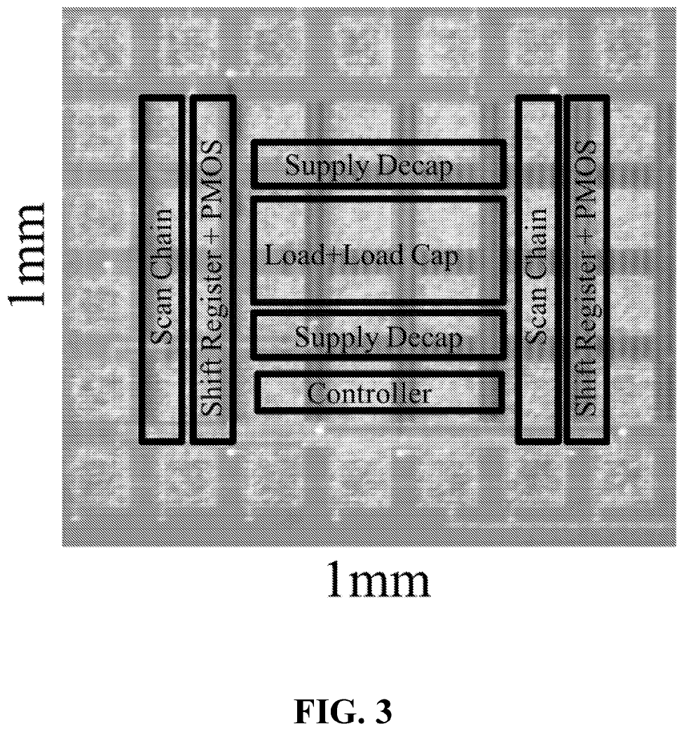

In a tested embodiment, the present design is fabricated in 65 nm CMOS process. The chip micrograph is shown in FIG. 3. The nominal supply voltage for high performance mode is 1.2 V. The LDO is designed to deliver a maximum load current of 125 mA at a dropout voltage of 600 mV occupying a total area of only 0.061 mm² excluding decoupling capacitor area.

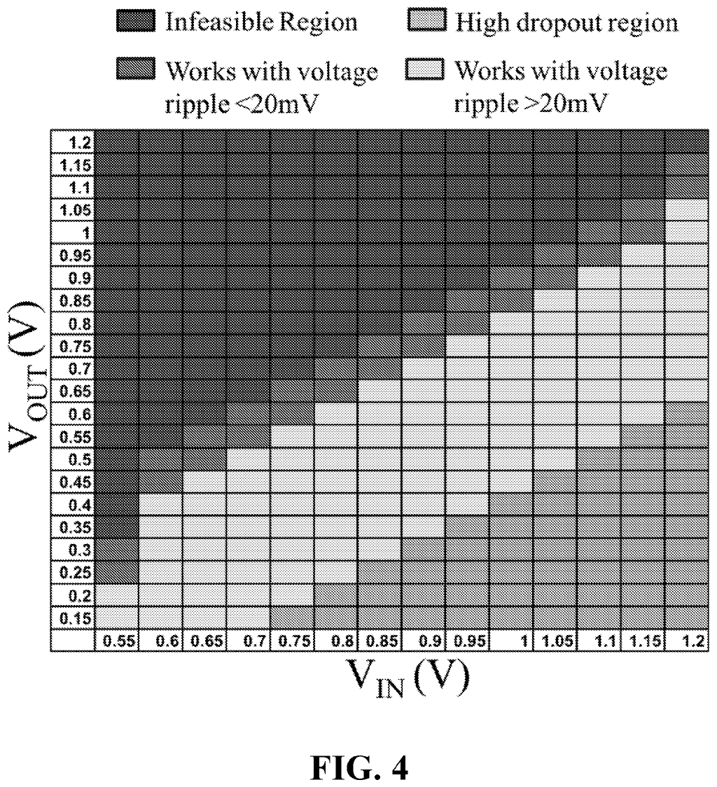

FIG. 4 presents the shmoo plot showing the operational range of the designed LDO. Given a simplistic low overhead design of the digital LDO, it can operate with a supply voltage from 0.55 V to 1.2 V. The regulated output voltage ranges from 0.15 V all the way up to 1.15 V with a minimum operational dropout voltage of only 50mV.

For a dropout voltage of greater than 100 mV, the steady-state voltage ripple of the design cannot be guaranteed to be less than 20 mV. This is because at an increased dropout voltage, the current contribution of each power transistor grows nonlinearly resulting in a larger ripple especially under light load current conditions. Advanced steady-state ripple mitigation techniques like clock adaptation and multiple size power stage quantization can be readily added to the present design, but are not discussed given the focus on the transient performance.

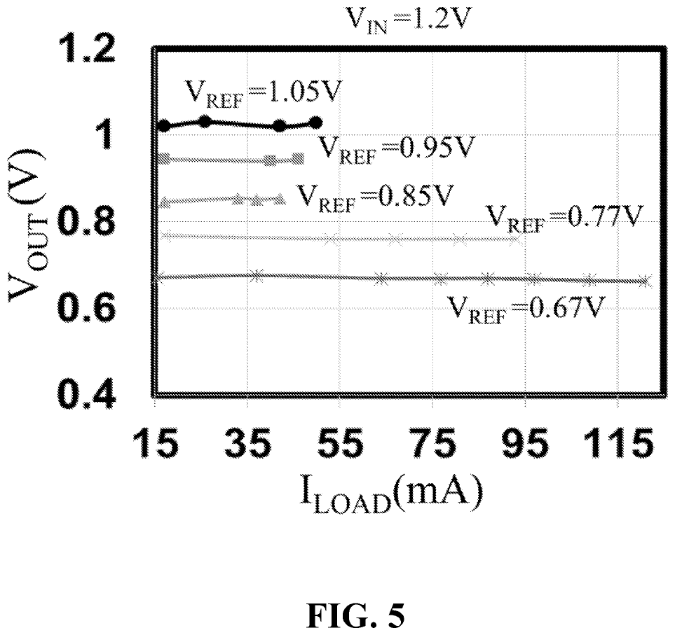

Load regulation measurements for different dropout volt-ages are covered in FIG. 5. The straight-line behavior of the curves across different dropout voltages show that load regulation remains constant across a large current range of 15 mA to 121 mA.

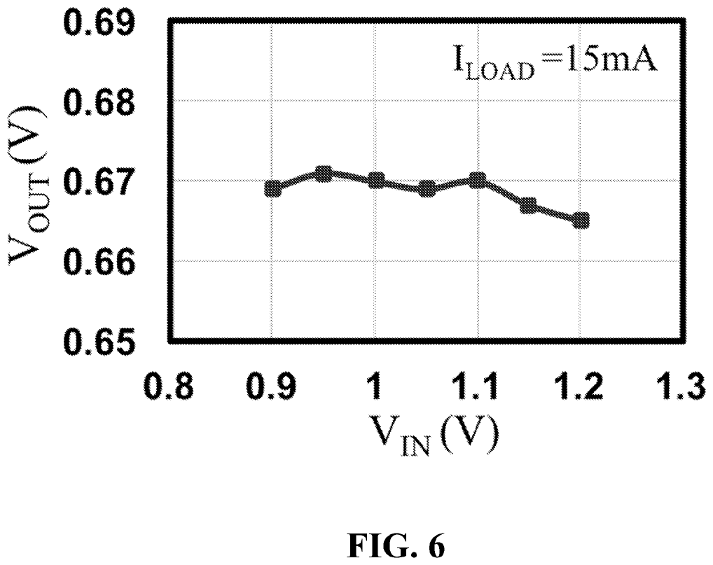

FIG. 6 shows line regulation measurements for reference voltage of 670 mV and load current of 15 mA when supply voltage varies from 0.9 to 1.2 V. A worst case error of 5 mV is measured at the highest dropout voltage.

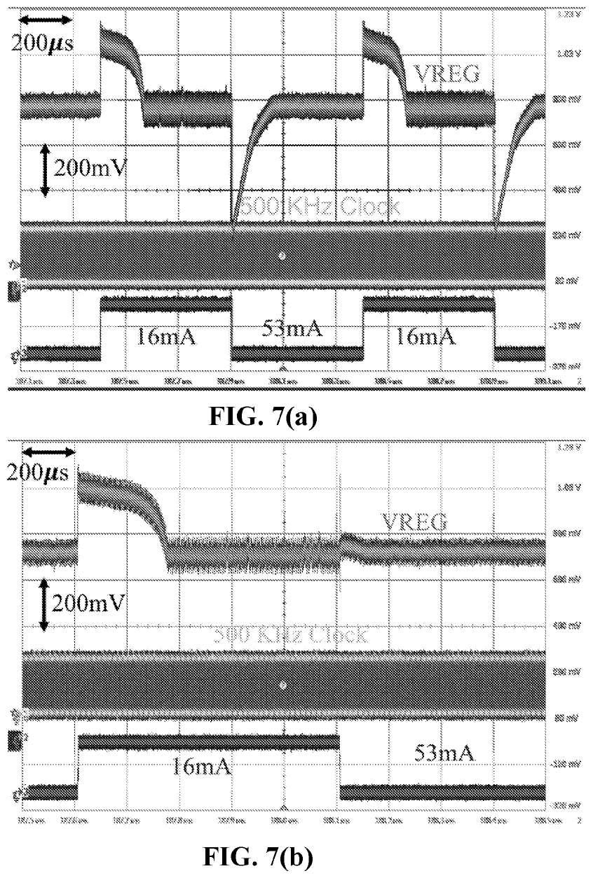

A comparison of asynchronous non-linear control digital LDO transient performance against a baseline digital only LDO captured on oscilloscope is shown in FIG. 7. The voltage droop reduces by 425 mV as compared to the baseline design for a load step of 16 to 53 mA in 1 μs transition time with C_{LOAD}=1nF, C_{IN}=2nF, and V_{REF}−Δ=750 mV. The clock is maintained at a low frequency of only 500 KHz showing optimal settling after non-linear recovery from a voltage droop.

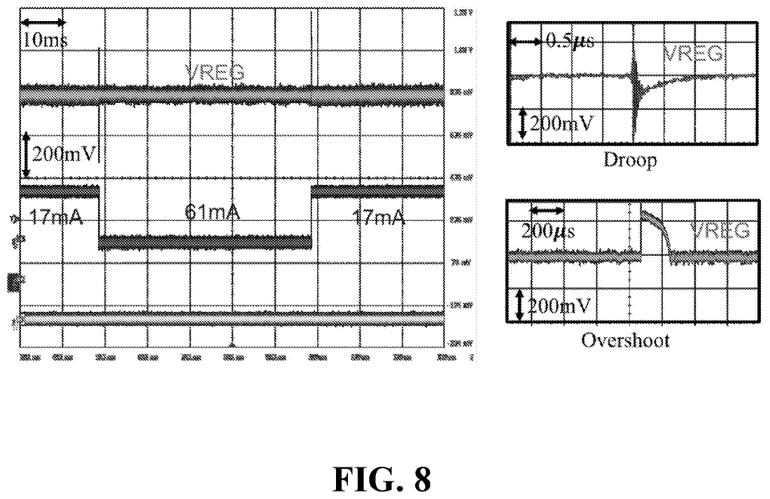

To account for varying decoupling capacitor budget and load transition rates, as expected in a digital load circuit, the supply capacitance is increased to 1 μF and load step transition edge is reduced to only 2 ns. Under such a scenario, a voltage droop of approximately 350 mV is measured for load step of 44 mA as shown in FIG. 8. Package and board resonances due to parasitic inductance contributes to the oscillatory behavior before the voltage settles. These second order effects are not observed for digital LDOs targeting a small current range of a few mA.

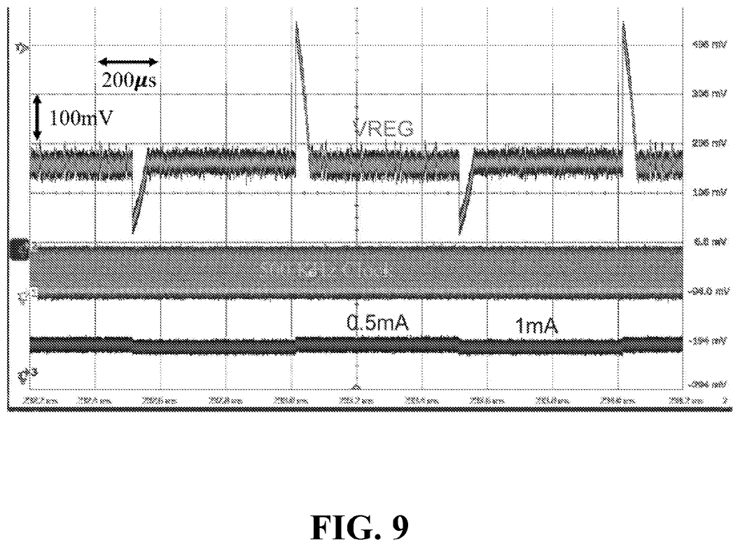

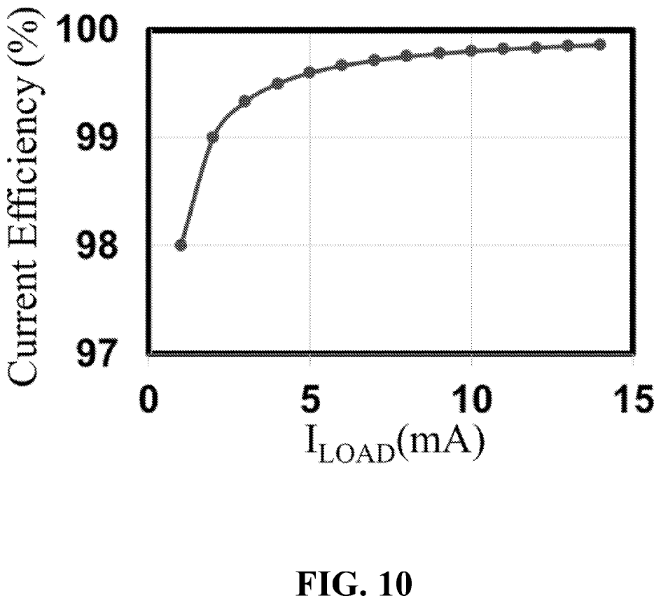

On the other hand, it proves the importance of designing a robust power delivery network to support high current and fast transient digital LDOs. Low regulation voltage operation of the proposed LDO is measured at 150 mV under a load step of 0.5 mA, as shown in FIG. 9. At low voltage operation, the droop comparator is non-operational and only the digital LDO is used. A measured quiescent current of only 20 μA, mostly consumed by the droop detection comparator, allows a measured current efficiency of greater than 99.5% for just 4 mA of load current as shown in FIG. 10. A comparison with current state-of-the-art designs show competitive performance of the proposed LDO as summarized in TABLE 1.

TABLE 1

| | The Present | | | | |
|---|---|---|---|---|---|
| | Invention | | | | |
| | DLDO with async, | | | | |
| | non-linear droop | REF. 1 | REF. 2 | REF. 3 | REF. 4 |
| Type | mitigation | Async, DLDO | DLDO | DLDO | DLDO |
| Process (nm) | 65 | 65 | 40 | 28 | 65 |
| V_{IN} (V) | 0.55-1.2 | 0.6-1 | 0.6-1.1 | 1.1 | 0.6-1.1 |
| V_{REG} (V) | 0.15-1.15 | 0.55-0.95 | 0.5-1 | 0.9 | 0.4-1 |
| I_{LOAD,MAX} (mA) | 125 | 500 | 210 | 200 | 100 |
| F_{CLOCK} (MHz) | 0.5 | — | N/A | N/A | 500 |
| C_{LOAD} (nF) | 1 | 1.5 | 20 | 23.5 | 1 |
| C_{IN} (nF) | 1-1000 | N/A | N/A | N/A | N/A |
| I_{Q} (uA) | 0-20 | 300 | 22.6-98.5 | 110 | 82 |
| Load Reg. (V/A) | <0.18 | 0.25 | 0.075 | N/A | 0.06 |
| Area (mm²) | 0.061 | 0.158 | 0.192 | 0.021 | 0.01 |
| Max Curr. | 99.99 | 99.99 | 99.99 | 98.94 | 99.92 |
| Efficiency (%) | | | | | |

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A voltage regulator comprising:
an output configured to provide an output voltage;
power transistors configured to switch between an on state and an off state;
power regulation circuitry configured switch, synchronously with the clock, the power transistors;
load sensing circuitry configured to sense, asynchronously with the clock, a decrease in the output voltage; and
control circuitry configured to transition, asynchronously with the clock, power transistors in the off state to the on state.

2. The voltage regulator of claim 1, wherein the control circuitry is configured to transition, asynchronously with the clock, every power transistor in the voltage regulator in the off state to the on state.

3. The voltage regulator of claim 1, wherein the load sensing circuitry comprises a clockless comparator.

4. The voltage regulator of claim 1, wherein the load sensing circuitry comprises:
an active load differential amplifier;
a common source amplifier; and
fast slew rate registers.

5. The voltage regulator of claim 1, wherein the control circuitry comprises shift registers;
wherein an output of the shift registers is in communication with the power transistors; and
wherein the shift registers each comprise a reset input.

6. The voltage regulator of claim 1, wherein the voltage regulator is configured to exhibit core-level load current driving capability of up to approximately 125 mA, and a voltage regulation range of approximately 0.15 V to approximately 1.15 V.

7. The voltage regulator of claim 1, wherein the voltage regulator is configured to have a peak current efficiency of greater than approximately 99.5% at a load of approximately 4 mA and approximately 1 nF load decoupling capacitance.

8. The voltage regulator of claim 1, wherein the voltage regulator is configured to have a nominal supply voltage of approximately 1.2 V.

9. The voltage regulator of claim 1, wherein the voltage regulator is configured to deliver a maximum load current of approximately 125 mA at a dropout voltage of approximately 600 mV occupying a total area of approximately 0.061 mm² excluding decoupling capacitor area.

10. The voltage regulator of claim 1, wherein the voltage regulator is configured to provide a regulated output voltage from approximately 0.15 V to approximately 1.15 V with a minimum operational dropout voltage of approximately 50 mV.

11. A voltage regulator comprising:
an output configured to provide an output voltage;
power transistors configured to switch between an on state and an off state;
shift registers configured to control the switching of the power transistors, wherein at least a portion of the shift registers each comprise a reset input;
a clockless comparator configured to compare the output voltage to a reference voltage, wherein the clockless comparator is in communication with at least a portion of the reset inputs.

12. The voltage regulator of claim 11, wherein the voltage regulator is configured to exhibit core-level load current driving capability of up to approximately 125 mA, and a voltage regulation range of approximately 0.15 V to approximately 1.15 V.

13. The voltage regulator of claim 11, wherein the voltage regulator is configured to have a peak current efficiency of greater than approximately 99.5% at a load of approximately 4 mA and approximately 1 nF load decoupling capacitance.

14. The voltage regulator of claim 11, wherein the voltage regulator is configured to have a nominal supply voltage of approximately 1.2 V.

15. The voltage regulator of claim 11, wherein the voltage regulator is configured to deliver a maximum load current of approximately 125 mA at a dropout voltage of approximately 600 mV occupying a total area of approximately 0.061 mm² excluding decoupling capacitor area.

16. The voltage regulator of claim 11, wherein the voltage regulator is configured to provide a regulated output voltage from approximately 0.15 V to approximately 1.15 V with a minimum operational dropout voltage of approximately 50 mV.

17. A method for asynchronous voltage recovery comprising:
providing a voltage regulator comprising digital power transistors, resettable registers, and a voltage comparator;
comparing, with the voltage comparator, an output voltage of the voltage regulator to a reference voltage;
providing, by the comparator, a reset signal to the resettable registers;
providing, by the resettable registers, an asynchronous control signal; and
activating, in response to the asynchronous control signal, each of the digital power transistors to an on state.

18. The method of claim 17 further comprising exhibiting core-level load current driving capability of up to approximately 125 mA, and a voltage regulation range of approximately 0.15 V to approximately 1.15 V.

19. The method of claim 17, wherein the voltage regulator is configured to have a peak current efficiency of greater than approximately 99.5% at a load of approximately 4 mA and approximately 1 nF load decoupling capacitance.

20. The method of claim 17, wherein the voltage regulator is configured to have a nominal supply voltage of approximately 1.2 V.

21. The method of claim 17, wherein the voltage regulator is configured to deliver a maximum load current of approximately 125 mA at a dropout voltage of approximately 600 mV occupying a total area of approximately 0.061 mm² excluding decoupling capacitor area.

22. The method of claim 17, wherein the voltage regulator is configured to provide a regulated output voltage from approximately 0.15 V to approximately 1.15 V with a minimum operational dropout voltage of approximately 50 mV.
